(19) United States
(12) Patent Application Publication
(10) Pub. No.: US 2017/0004282 A1
(43) Pub. Date: Jan. 5, 2017

(54) PROCESSING ENROLLMENT INTO PATIENT SUPPORT CENTERS FOR PRESCRIPTION MEDICATIONS

(71) Applicant: CoverMyMeds LLC, Columbus, OH (US)

(72) Inventors: Matthew A. Scantland, Upper Arlington, OH (US); Amanda Way, Columbus, OH (US); Mark Lorenz, Powell, OH (US); Patricia Yacovone-Biagi, Worthington, OH (US); Zachary Serafini, Columbus, OH (US); Erica Conroy, Columbus, OH (US)

(21) Appl. No.: 15/193,516

(22) Filed: Jun. 27, 2016

Related U.S. Application Data
(60) Provisional application No. 62/188,425, filed on Jul. 2, 2015.

(51) Int. Cl. G06F 19/00; G06F 17/30; G06F 3/0484; H04L 29/06

(52) U.S. Cl. CPC G06F 19/3456; H04L 63/102; H04L 63/08; G06F 17/30867; G06F 19/328; G06F 19/3418; G06F 3/0484

(57) ABSTRACT

Systems and methods for facilitating enrollment into a patient support center for a medication are provided. The systems and methods can be configured to receive information from a prescriber regarding a prescription medication for a patient; determine whether the prescription medication is associated with a patient support center; communicate to the prescriber an inquiry regarding whether to enroll the patient in the patient support center; receive a request from the prescriber to begin an enrollment of the patient into the patient support center; communicate to the prescriber an interface by which the prescriber can input information regarding enrollment of the patient into the patient support center; receive an indicia of patient agreement to the enrollment into the patient support center; and communicate the patient enrollment information to the patient support center. The systems and methods may also facilitate electronic submission of a request for prior authorization for the medication.

### CROSS-REFERENCE TO RELATED APPLICATIONS

This application claims the benefit of priority under 35 U.S.C. §119(e) to U.S. patent application Ser. No. 62/188,425, filed Jul. 2, 2015, entitled “APPARATUS AND METHOD FOR PROCESSING ENROLLMENT INTO PATIENT SUPPORT CENTERS FOR PRESCRIPTION MEDICATIONS,” which is hereby incorporated by reference herein in its entirety for all it discloses.

### BACKGROUND

Field

Computer-implemented methods and apparatus are provided for facilitating enrollment by patients into a patient support center for a prescription medication.

Description of the Related Art

The cost of prescription drugs may be covered by a health insurance plan. At least a portion of the costs of prescription drugs covered by the health insurance plan may be paid on behalf of the patient by the health insurance provider. Other prescription drugs falling outside of the coverage of a health insurance plan must be paid for, in full, out of pocket by the patient or other recipient of such prescription drugs.

Whether a prescription drug is or is not covered by a health insurance plan is not always readily determinable. For example, certain dosages or concentrations of a prescription drug may be covered, while others are not. Likewise, a prescription drug covered as an accepted treatment for a first medical condition may not be covered to treat a different medical condition, because it may be uncertain whether the prescription drug constitutes an effective treatment for that different medical condition. A prescription for a drug with a generic equivalent available may also be covered, but only if there is a reason why the generic equivalent is unsuitable.

### SUMMARY

An embodiment of a system for facilitating enrollment into a patient support center for a medication is provided. The system comprises non-transitory computer storage configured to store information on enrollment forms for a plurality of patient support centers, each patient support center associated with a medication for prescription to patients, and an enrollment platform in communication with the non-transitory computer storage. The enrollment platform comprises computer hardware having a plurality of modules stored in a memory, with the plurality of modules comprising an enrollment module. The enrollment module is programmed to: receive information from a prescriber regarding a prescription medication for a patient; determine whether the prescription medication is associated with a patient support center; communicate to the prescriber an inquiry regarding whether to enroll the patient in the patient support center; receive a request from the prescriber to begin an enrollment of the patient into the patient support center; communicate to the prescriber an interface by which the prescriber can input information regarding enrollment of the patient into the patient support center; receive an indicia of patient agreement to the enrollment into the patient support center; and communicate the patient enrollment information to the patient support center.

An embodiment of a method for facilitating enrollment into a patient support center for a medication is provided. The method is performed under control of an enrollment platform comprising computer hardware. The method comprises receiving information from a prescriber regarding a prescription medication for a patient; determining whether the prescription medication is associated with a patient support center; communicating to the prescriber an inquiry regarding whether to enroll the patient in the patient support center; receiving a request from the prescriber to begin an enrollment of the patient into the patient support center; communicating to the prescriber an interface by which the prescriber can input information regarding enrollment of the patient into the patient support center; receiving an indicia of patient agreement to the enrollment into the patient support center; and communicating the patient enrollment information to the patient support center.

An embodiment of a system for facilitating enrollment into a patient support center for a medication is provided. The system comprises non-transitory computer storage configured to store information on enrollment forms for a plurality of patient support centers, each patient support center associated with a medication for prescription to patients and an enrollment platform in communication with the non-transitory computer storage. The enrollment platform comprises computer hardware having a plurality of modules stored in a memory. The plurality of modules comprise an enrollment module programmed to: receive a request to enroll a patient in a patient support center; and select a patient enrollment form from the plurality of enrollment forms, wherein the selection is based at least in part on information in the request.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1 is an example method for enrolling a patient into a hub program in which a prescriber can search for, fill out, and submit a hub enrollment via a networked system.

FIG. 2 is an example method for enrolling a patient into a hub program in which the system can automatically detect that a hub program is affiliated with a medication being prescribed to a patient by a prescriber.

FIG. 3 schematically illustrates an example of a system for processing hub enrollments for prescription medications.

FIGS. 4A-4D show examples of user interfaces that can be used by a subscriber to elect participation of a patient in a hub enrollment program.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

### Overview

When it is unknown whether insurance coverage for a prescription drug is available, a request for prior authorization (PA) to fulfill a prescription for a drug under the coverage of a health insurance plan can be submitted to the health insurance plan. The request for PA may be a form (paper or electronic) with a number of information fields (e.g., patient and physician information, insurance plan information, drug information, etc.) to be completed by the pharmacy and/or prescribing physician. Each health insurance provider may have its own individual form for a particular drug and/or particular insurance plan. In one example of submitting such a request, the pharmacy fulfilling the drug prescription can enter the information pertaining to the patient, drug and health insurance plan into an appropriate form. The at-least-partially-completed PA request form can be transmitted to the physician who prescribed the drug and/or the patient in order to be completed before being submitted to the health insurance provider. The health insurance provider can then make a determination as to whether the patient's insurance plan provides at least some coverage for the prescribed drug.

Electronic prior authorization platforms can make the PA request form accessible from within a user account associated with the prescribing physician. For example, the prescribing physician may access the PA platform via a network (such as the Internet) using a graphical user interface (e.g., a web browser). Examples of computerized methods and apparatus for accessing, completing, and processing prior authorization requests for prescription drugs are described in U.S. Patent Application Publication No. 2011/0257992 to Scantland et al., which is hereby incorporated by reference herein in its entirety for all it discloses (the “992 Publication”).

A prescribing physician or other authorized party affiliated with the physician (e.g., the physician's office staff) will generally be hereinafter referred to generically as the “prescriber” for the sake of brevity. Further, the term physician can include a medical doctor (MD), a doctor of osteopathic medicine (DO), a physician assistant (PA), an optometrist (DO), a podiatrist (DPM), a dentist (DDS or DDM), a veterinarian (DVM), an advanced practice medical nurse (APRN), a clinical pharmacist, a medical or nurse practitioner, a medical psychologist, or any other person authorized or licensed to prescribe medications. The term medication includes drugs, medicines, pharmaceuticals, medicaments, medicinal products, medical devices or appliances, or any other substance, device, or apparatus having properties for treating or preventing disease in humans or animals.

### Patient Support Centers (“Hubs”)

Pharmaceutical companies have established specialty programs called patient support centers or “hubs”, which are customer service organizations typically centered around a single specialty medication (e.g., a drug with a limited number of patients—often an oncology drug). The hub provides a variety of services to patients, including helping with insurance benefit verification, contacting pharmacy benefit managers to urge prior authorization, arranging for delivery of drugs (some must remain refrigerated), and following up with the patient to monitor their dosing regimen.

However, prescribers, and especially patients, often remain unaware of the existence of a hub program associated with a certain drug, or how to enroll in the hub. Likewise, drug companies are not advised when a prescription is written for the specialty drug. Consequently, many patients who would benefit from a hub program are not enrolled, and drug companies are forced to inefficiently advertise or directly contact prescribers to spread awareness of their hub program and encourage enrollment.

### Example Systems and Methods for Facilitating Patient Enrollment in a Hub

Various embodiments of the disclosed technology can address one or both of the foregoing challenges by facilitating enrollment in pharmaceutical companies' hubs. Some of these embodiments can implement one or more of the following general techniques.

1. Hub Enrollment by Search

Hub enrollment forms can be added to a searchable forms library, which may also include PA forms. Hub enrollment forms can be searched for, filled out online, and submitted to a third party, in a generally similar way, and using a generally similar interface, as for prior authorization forms as described in the '992 Publication. Prescribers who are aware of (or want to search for) the existence of a hub program can therefore directly locate and execute enrollment materials for hubs.

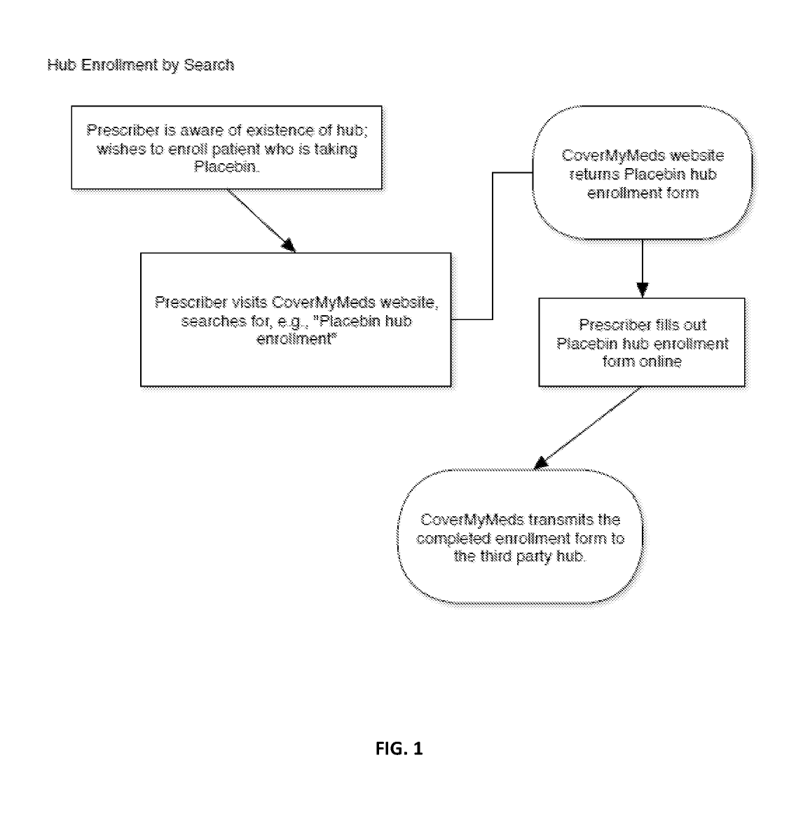

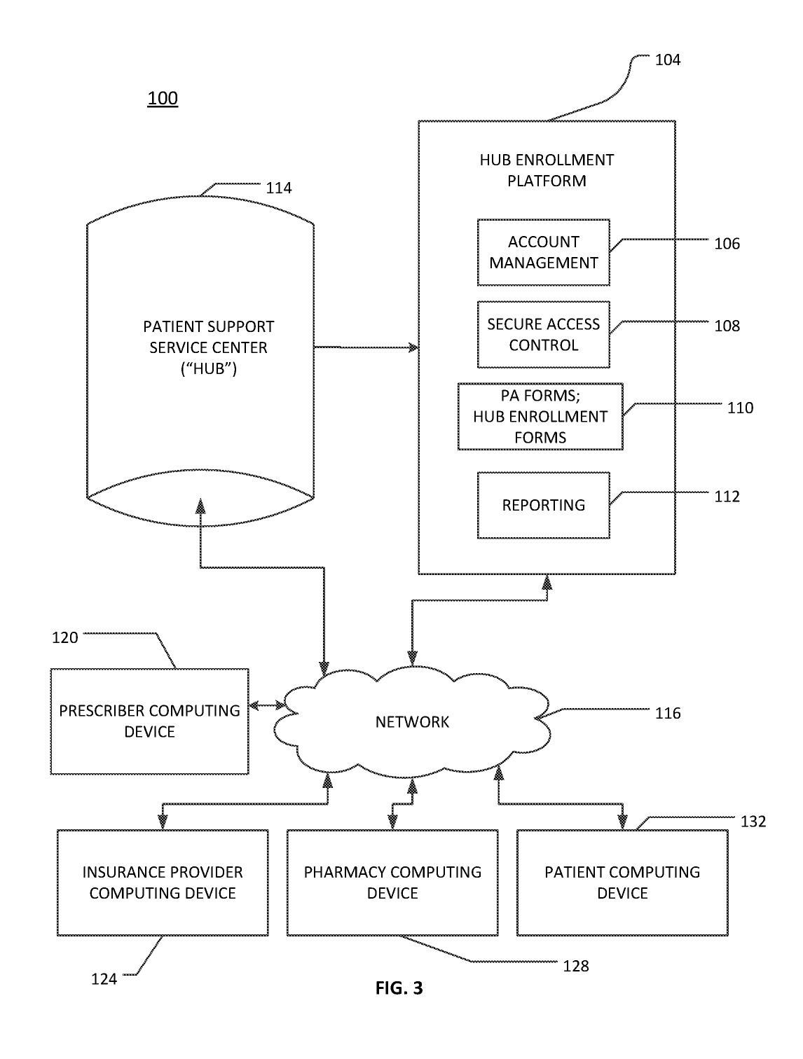

FIG. 1 is an example method for enrolling a patient into a hub program in which a prescriber can search for, fill out, and submit a hub enrollment. In this illustrative, non-limiting example, the medication to be prescribed to the patient is named “Placebin” and the online, networked enrollment system is provided by CoverMyMeds, LLC (Columbus, Ohio) (“CoverMyMeds”). The method shown in FIG. 1 can be performed via a networked system similar to those described in the '992 Publication or the system 100 described herein with reference to FIG. 3 or online, networked, enrollment systems provided by CoverMyMeds.

2. Hub Enrollment by Suggestion

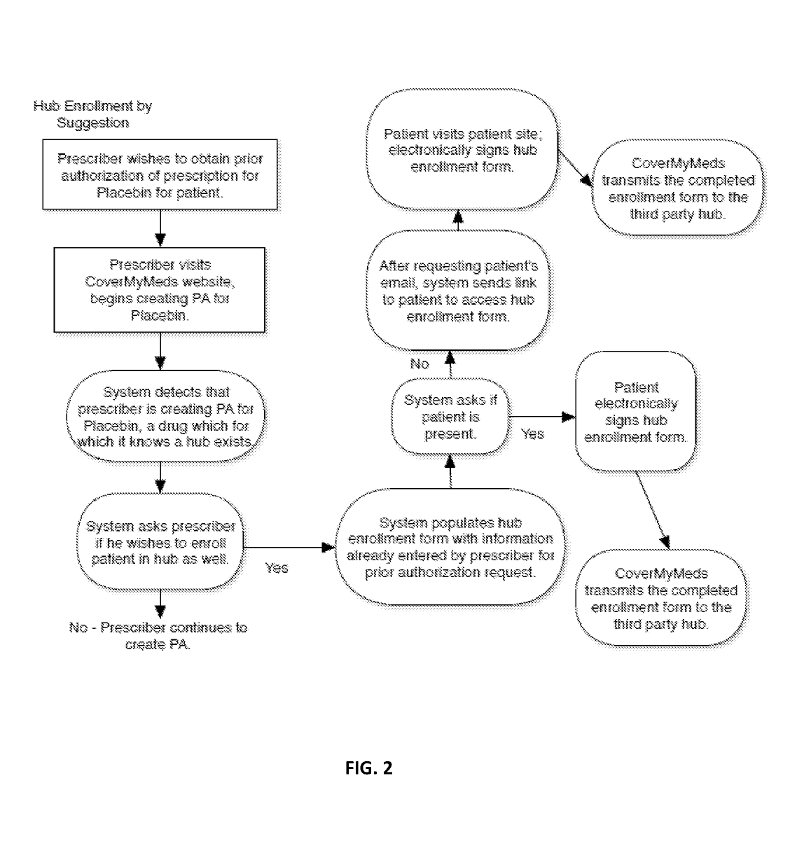

FIG. 2 is an example method for enrolling a patient into a hub program in which the system can automatically detect that a hub program is affiliated with a medication being prescribed to a patient by a prescriber. In this illustrative, non-limiting example, the medication to be prescribed to the patient is named “Placebin” and the online, networked enrollment system is provided by CoverMyMeds.

When a prescriber uses an electronic health record (EHR) system (such as embodiments of the systems described in the '992 Publication, the system 100 described with reference to FIG. 3, or systems provided by CoverMyMeds) to fill out, online, a prior authorization request for a medication, the system can check whether the medication in question is known to the system to have an affiliated hub program. If an affiliated hub program exists for the medication, the system can automatically communicate an inquiry to the prescriber regarding whether the prescriber wishes to enroll the patient in the affiliated hub program. For example, the system may insert into the prior authorization request form a question asking whether the prescriber wishes to enroll the patient in the hub program. As another example, the system may cause a pop-up window, with the inquiry, to appear on a user interface presented to the prescriber. The prescriber may select an appropriate button (e.g., “yes” or “no”) from the pop-up window to proceed (or not) with enrollment in the hub program.

If the prescriber answers in the affirmative (e.g., to the question in the form or in the pop-up window), the system uses the information already populated on the prior authorization form to populate the hub enrollment form, prompting for any additional information required (including, if necessary, information concerning the parent or guardian of a minor patient).

Due to patient confidentiality concerns, the patient's authorization is generally required to enroll the patient in the hub. Accordingly, the system can ask whether the patient is physically present with the prescriber. If so, the system displays an electronic signature box for the patient to sign. Upon execution by the patient, the hub enrollment form is automatically generated and transmitted to the third party pharmaceutical hub program (e.g., via electronic mail, electronic facsimile, etc.).

If the patient is not physically present, the system can prompt the prescriber for an electronic mail address for the patient. The system then transmits to the patient, using the electronic mail address, a hyperlink and login key, for the patient to use to log into a website, wherein the patient can sign an electronic signature box as described above, and have the hub enrollment form generated and transmitted to the third party pharmaceutical hub program.

Accordingly, various embodiments of an EHR system (which may be an embodiment of a PA system as described in the '992 Publication or an embodiment of the system 100 described with reference to FIG. 3 or an enrollment and PA system provided by CoverMyMeds) can implement one or both of the methods described in FIGS. 1 and 2 to facilitate enrollment of a patient in a hub.

3.Example Hub Enrollment System

FIG. 3 schematically illustrates an example of a system 100 for processing hub enrollments for prescription medications. The system may also process PA requests. The system 100 can implement the PA techniques described in the '992 Publication or PA techniques performed by online, electronic PA systems provided by CoverMyMeds. The system 100 includes a hub enrollment platform 104 configured to communicate over a network 116 with one or more computing devices such as a prescriber computing device 120, an insurance provider computing device 124, a pharmacy computing device 128, or a patient computing device 132. The system 100 can communicate with a third-party patient support center (“hub”) for a particular medication. As will be further discussed below, in certain implementations, the hub enrollment platform 104 can include various modules including an account management module 106, a secure access control module 108, a forms module 110 (which can store PA or hub enrollment forms), and a reporting module 112. The hub platform 104 may be maintained by, or on behalf of an insurance provider or by a third-party intermediary that is independent of health insurance providers. The hub platform 104 can communicate with a third-party pharmaceutical hub program 114 (e.g., via the network 116). Embodiments of the hub enrollment platform 104 can perform hub enrollment by search and/or hub enrollment by suggestion (see, e.g., FIGS. 1 and 2).

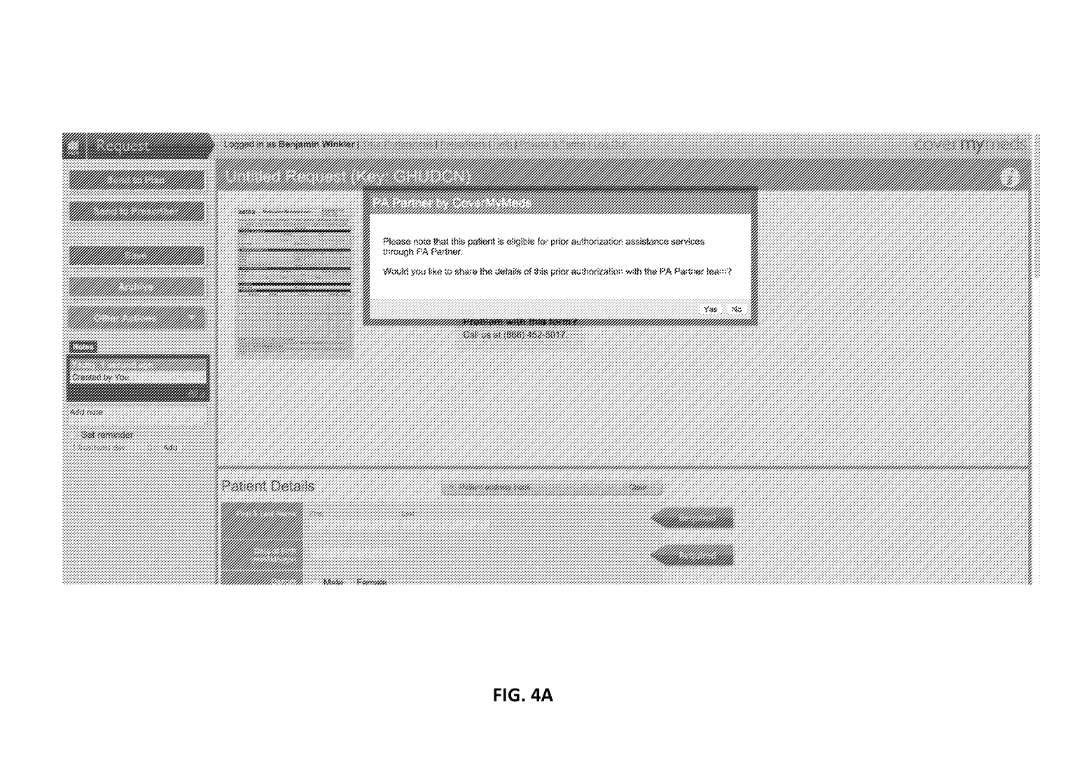

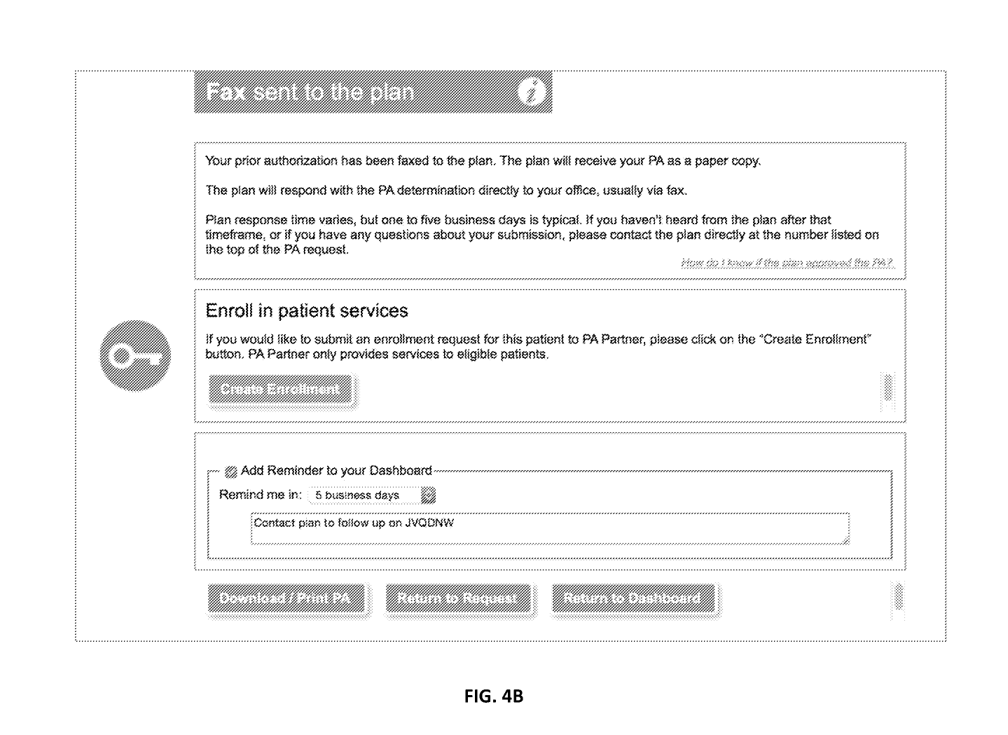

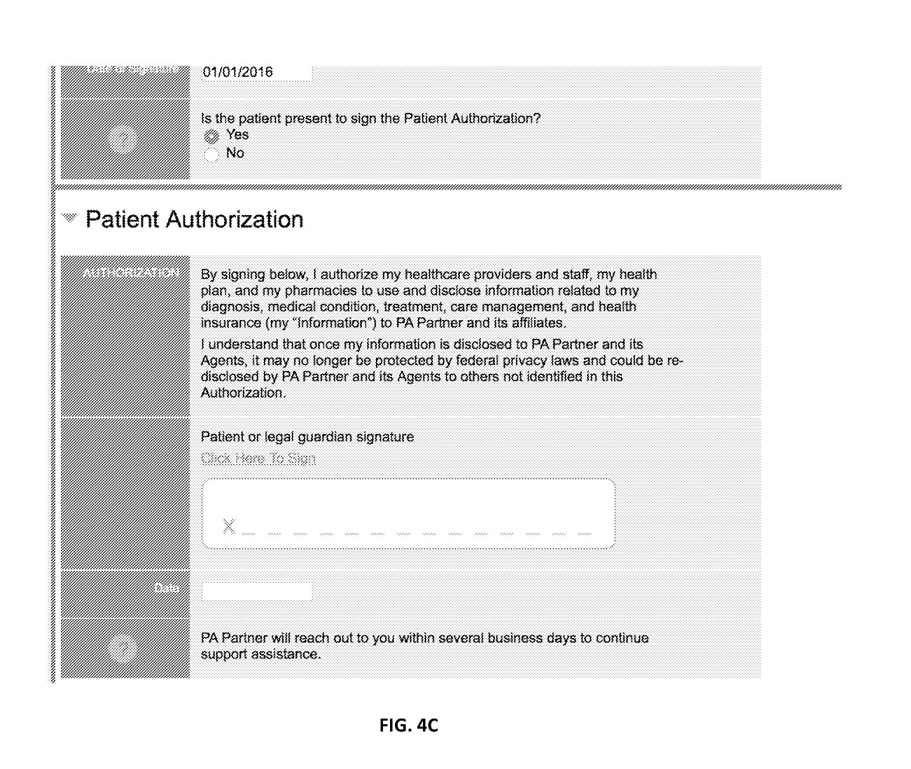

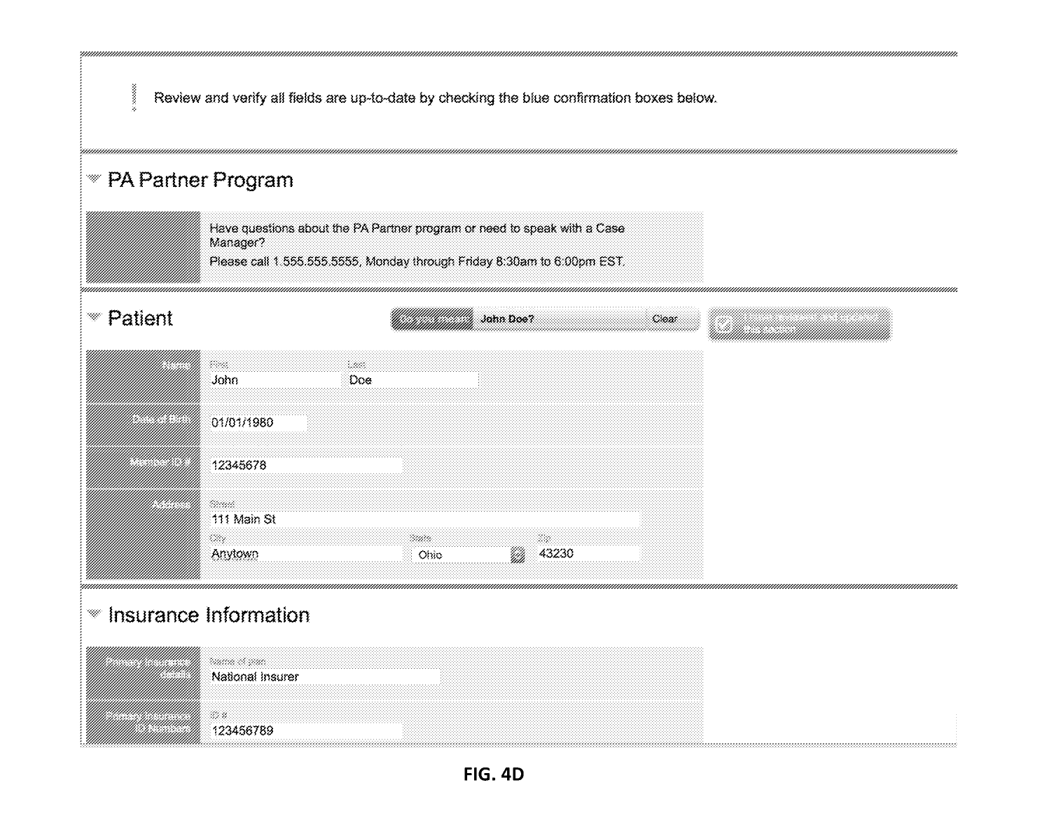

The hub enrollment platform 104 can be implemented on computer hardware, such as one or more physical computer servers programed with specific computer-executable instructions. The modules 106-112 can comprise computer software instructions executed by hardware computing devices. The computing devices 120-132 can include general purpose computers, servers, data input devices (e.g., terminals or displays), web interfaces, portable or mobile computers, laptops, or tablets, smart phones, etc. The computing devices 120-132 can include user interfaces to allow users to communicate with the hub enrollment platform 104 over the network 116 (see, e.g., FIGS. 4A-4D). The computing devices 120-132 can additionally or alternatively include software applications that can communicate with the PA platform, for example by using a suitable Application Program Interface (API). The network 116 can provide wired or wireless communication between the computing devices 120-132 and the hub enrollment platform 104. In various implementations, the hub enrollment platform 104 can include data storage and/or be configured to communicate over the network 116 with data storage devices. The network 116 can be configured as a local area network (LAN), a wide area network (WAN), the Internet, an intranet, combinations of the same, or the like. In certain embodiments, the network 116 can be configured to support secure shell (SSH) tunneling or other secure protocol connections for the transfer of data between the hub enrollment platform 104 and the computing devices 120-132.

The hub enrollment platform 104 includes the account management module 106 that can handle creation and maintenance of user accounts on the platform. For example, a prescriber can access the hub enrollment platform via a user interface on the prescriber computing device 120 to request an account. The prescriber may be asked to provide publicly-available information that can include, for example, the prescriber's name, address, telephone number, facsimile (fax) number, electronic mail (email) address, and so forth. The prescriber can also be identified based at least in part on a prescriber identification token that is uniquely associated with the prescriber. For example, the prescriber identification token can include the physician's National Provider Identifier (NPI), which is a unique 10-digit identification number issued to health care providers in the United States by the Centers for Medicare and Medicaid Services as mandated by the Health Insurance Portability and Accountability Act (HIPAA). Information such as the NPI is commonly included with a prescription for the medication prescribed by the prescriber.

The account management module 106 (or the secure access control module 108) may associate the account with the prescriber identification token so that the account can be uniquely identified and/or securely authorized. The prescriber may be able to access the account by utilizing a user interface that allows the prescriber to enter the prescriber identification token (e.g., the prescriber's NPI) and a password.

The hub enrollment platform 104 can facilitate the process of obtaining a PA for a prescription medication and/or facilitate the process for enrolling the patient into a hub for the prescription medication. In the following illustrative example, a user such as a pharmacy or a prescriber (or their authorized representatives), can access the hub enrollment platform 104 (e.g., via the computing device 120, 128 over the network 116) and set up or login to an account on the platform. For example, the account management module 106 can be configured to receive a login identification and password.

The user can select whether to create a new form or update an existing form for a patient's medication. The form can be a PA form or a hub enrollment form. The user can input search terms, for example, the state in which the PA or hub enrollment request is being made, the identity of the patient's health insurance provider, and/or the prescription drug for which the PA request or hub enrollment is being made. The user can select an appropriate PA form or hub enrollment form from a selection of electronic forms provided by the forms module 110 of the PA platform 104. The forms module 110 can include various formats of PA or hub enrollment forms such as, for example, visual PDF representations as well as machine-readable data representations, including, for example, extensible markup language (XML), JavaScript object notation (JSON), or flat text. As described above with reference to FIG. 1, the prescriber thus can search for, fill out, and submit the hub enrollment form using the system 100.

Additionally or alternatively, and as described with reference to FIG. 2, the system 100 can check (during the PA request process) whether the medication in question is known to the system 100 to have an affiliated hub program. For example, the system 100 may maintain a data store that stores an association between medications and related hub program(s). If the PA request being filled out by the prescriber is associated with a hub, the system 100 can automatically insert into the prior authorization request form (or user interface) a question asking the prescriber whether he wishes to enroll his patient in the hub program. If the prescriber answers in the affirmative, the system 100 uses the information already populated on the prior authorization form to populate the hub enrollment form, prompting for any additional information required (including, if necessary, information concerning the parent or guardian of a minor patient). As described above, the system 100 can ask whether the patient is physically present with the prescriber. If so, the system 100 displays an electronic signature box for the patient to sign. Upon execution by the patient, the hub enrollment form is automatically generated and transmitted to the third party pharmaceutical hub program (e.g., via electronic mail, electronic facsimile, etc.). If the patient is not physically present, the system 100 can prompt the prescriber for an electronic mail address for the patient. The system 100 then transmits to the patient computing device 132 a link and login key, for the patient to use to log into a website, wherein the patient can sign an electronic signature box as described above, and have the hub enrollment form generated and transmitted to the third party pharmaceutical hub program 114.

The user can input information into the form (e.g., via text entry fields in the form) that is required by the insurance provider to make a decision on the PA requests or hub enrollment. In some cases, the platform 104 may auto-populate one or more fields on the form. The form (or information entered into such forms) can be transmitted over the communication network 116. For example, a pharmacist may begin entry of information into the form but need additional information from the prescriber (or the patient) to complete the form before it is sent to the insurance provider or a hub. The platform 104 can communicate the form (or the appropriate information) to the prescriber for completion of the form.

The prescriber can access the partially-completed form by logging in to the prescriber's account on the platform 104. The prescriber can complete the remaining required fields on the form, electronically sign the form, and submit the form to the health insurance provider or hub via the platform 104. Upon receiving the completed form, the health insurance provider or hub can determine whether to approve, deny, cancel, or request additional information for the form. The health insurance provider can be an insurance company, a pharmacy benefits manager (PBM), an administrator of a prescription drug program, or other entity responsible or authorized to process and/or pay prescription medication claims.

The platform 104 can include the reporting module 112, which can perform various administrative functions for the system 100. For example, the reporting module 112 can perform reporting, auditing, logging, and other communication functions with managers, administrators, and users of the system 100. For example, the reporting module 112 can store a copy of the completed form (or the information used to populate the form). The reporting module 112 may also log (or store a log of) successful transactions or communications between, for example, a pharmacist and a prescriber or a hub and the prescriber.

4.Example Hub Enrollment User Interfaces

FIGS. 4A-4D are screenshots showing examples of user interfaces that can be used by a subscriber to elect participation of a patient in a hub enrollment program. The hub enrollment platform 104 may cause communication of such user interfaces to the prescriber's computing platform. In these examples, the hub enrollment platform 104 may be referred to as “PA Partner”. These user interface examples are intended to illustrate features of the hub enrollment platform 104 and not to be limiting; for example, the user interfaces can be arranged differently than shown in these examples.

As described above, the platform 104 may be aware that a particular medication is affiliated with a hub program. FIG. 4A shows a pop-up window that may be generated for display to the prescriber, which alerts the prescriber to the hub program or that there is assistance for prior authorization services. The pop-window provides “yes” and “no” buttons by which the prescriber can choose whether or not to proceed with enrollment of the patient in the hub or for prior authorization services.

FIG. 4B shows an another example of a user interface that includes a portion to “Enroll in patient services”. If the prescriber chooses to enroll the patient in the patient services (e.g., a hub, prior authorization services, etc.), the user interface presents a button “Create Enrollment” that can be selected by the prescriber to submit an enrollment request.

As described above, due to patient confidentiality concerns, the patient's authorization is generally required to enroll the patient in the hub or other patient services. Accordingly, the hub enrollment platform 104 can communicate an inquiry as to whether the patient is physically present with the prescriber. If so, the platform 104 can generate for presentation to the prescriber and the patient an electronic signature box for the patient to sign. Upon execution by the patient, the hub enrollment form is automatically generated and transmitted to the third party pharmaceutical hub program (e.g., via electronic mail, electronic facsimile, etc.). FIG. 4C illustrates an example user interface showing the inquiry to the prescriber regarding whether the patient is present, with radio buttons for communicating a yes or no response to the inquiry. The user interface also shows a “Patient Authorization” section with a region (e.g., a signature box) where the patient can enter his or her signature to assent to enrollment into the hub program.

FIG. 4D shows an example user interface providing contact information for assistance about the hub enrollment or patient services (e.g., a telephone number and availability times). The user interface also shows information about the patient and the patient's insurance company.

### Other Considerations

All of the processes and process steps described above (including those of FIGS. 1 and 2) may be embodied in, and fully automated via, software code modules executed by one or more general purpose computers or computing devices programmed with specific computer-executable instructions. The code modules or the resulting data or output from the processes may be stored in any type of non-transitory computer-readable medium or other computer storage or storage device. As mentioned above, some or all of the methods or steps may alternatively be embodied in specialized computer hardware. The results of the disclosed methods and tasks may be persistently stored by transforming physical storage devices, such as solid state memory chips and/or magnetic disks, into a different state.

Thus, all of the methods and tasks described herein may be performed and fully automated by a programmed or specially configured computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium.

Further, certain implementations of the functionality of the present disclosure are sufficiently mathematically, computationally, or technically complex that application-specific hardware or one or more physical computing devices (utilizing appropriate specialized executable instructions) may be necessary to perform the functionality, for example, due to the volume or complexity of the calculations involved or the volume of the data to be processed or to provide results substantially in real-time.

Code modules may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes and process steps (or any data accessed or used) may be stored, persistently or otherwise, in any type of non-transitory, tangible computer storage or may be communicated via a computer-readable transmission medium.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer or software product or packaged into multiple computer or software products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network (e.g., a terrestrial and/or satellite network) or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and any appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing description is intended to illustrate, and not limit, the inventive subject matter. The scope of protection is defined by the claims. In the following claims, any reference characters are provided for convenience of description only, and not to imply that the associated steps must be performed in a particular order.

What is claimed is:

1. A system for facilitating enrollment into a patient support center for a medication, the system comprising:
non-transitory computer storage configured to store information on enrollment forms for a plurality of patient support centers, each patient support center associated with a medication for prescription to patients;
an enrollment platform in communication with the non-transitory computer storage, the enrollment platform comprising computer hardware having a plurality of modules stored in a memory, the plurality of modules comprising:
an enrollment module programmed to:
receive information from a prescriber regarding a prescription medication for a patient;
determine whether the prescription medication is associated with a patient support center;
communicate to the prescriber an inquiry regarding whether to enroll the patient in the patient support center;
receive a request from the prescriber to begin an enrollment of the patient into the patient support center;
communicate to the prescriber an interface by which the prescriber can input information regarding enrollment of the patient into the patient support center;
receive an indicia of patient agreement to the enrollment into the patient support center; and
communicate the patient enrollment information to the patient support center.

2. The system of claim 1, wherein the information on enrollment forms for the plurality of patient support centers comprises a prescriber-searchable library of enrollment forms.

3. The system of claim 1, wherein the interface by which the prescriber can input information regarding enrollment of the patient into the patient support center is configured to accept input that the patient is present with the prescriber and consents to enrollment in the patient support center.

4. The system of claim 3, wherein the input comprises an electronic signature box.

5. The system of claim 1, wherein the interface by which the prescriber can input information regarding enrollment of the patient into the patient support center is configured to:
accept input that the patient is not present with the prescriber;
receive or access an electronic communication address associated with the patient; and
communicate, using the electronic communication address, information permitting the patient to submit the indicia of patient agreement to the enrollment into the patient support center.

6. The system of claim 5, wherein the information permitting the patient to submit the indicia of patient agreement comprises a hyperlink to an online web service that permits entry of an electronic patient signature.

7. The system of claim 1, wherein the plurality of modules further comprises a prior authorization module programmed to make available to the prescriber a request for prior authorization of the prescription medication for the patient.

8. The system of claim 1, wherein the plurality of modules further comprises a secure access control module programmed to securely authenticate an account of the prescriber.

9. A method for facilitating enrollment into a patient support center for a medication, the method comprising:
under control of an enrollment platform comprising computer hardware:
receiving information from a prescriber regarding a prescription medication for a patient;
determining whether the prescription medication is associated with a patient support center;
communicating to the prescriber an inquiry regarding whether to enroll the patient in the patient support center;
receiving a request from the prescriber to begin an enrollment of the patient into the patient support center;
communicating to the prescriber an interface by which the prescriber can input information regarding enrollment of the patient into the patient support center;
receiving an indicia of patient agreement to the enrollment into the patient support center; and
communicating the patient enrollment information to the patient support center.

10. The method of claim 9, wherein receiving the indicia of patient agreement to the enrollment into the patient support center comprises receiving input that the patient is present with the prescriber and consents to enrollment in the patient support center.

11. The method of claim 9, wherein receiving the indicia of patient agreement to the enrollment into the patient support center comprises:
accepting input that the patient is not present with the prescriber;
receiving or accessing an electronic communication address associated with the patient; and
communicating, using the electronic communication address, information permitting the patient to submit the indicia of patient agreement to the enrollment into the patient support center.

12. A system for facilitating enrollment into a patient support center for a medication, the system comprising:
non-transitory computer storage configured to store information on enrollment forms for a plurality of patient support centers, each patient support center associated with a medication for prescription to patients;
an enrollment platform in communication with the non-transitory computer storage, the enrollment platform comprising computer hardware having a plurality of modules stored in a memory, the plurality of modules comprising:
an enrollment module programmed to:
receive a request to enroll a patient in a patient support center; and
select a patient enrollment form from the plurality of enrollment forms, wherein the selection is based at least in part on information in the request.

13. The system of claim 12, wherein the information on enrollment forms for the plurality of patient support centers comprises a prescriber-searchable library of enrollment forms.

14. The system of claim 13, wherein the system provides a user interface that permits the prescriber to search for a patient enrollment form for a particular patient support center.

15. The system of claim 12, wherein the enrollment module is programmed receive an indicia of patient agreement to the enrollment into the patient support center.

16. The system of claim 15, wherein the enrollment module is programmed to provide an electronic signature box for the patient.

17. The system of claim 15, wherein the enrollment module is programmed to:
receive input that the patient is not present with the prescriber;
receive or access an electronic communication address associated with the patient; and
communicate, using the electronic communication address, information permitting the patient to submit the indicia of patient agreement to the enrollment into the patient support center.

18. The system of claim 17, wherein the information permitting the patient to submit the indicia of patient agreement comprises a hyperlink to an online web service that permits entry of an electronic patient signature.

19. The system of claim 12, wherein the plurality of modules further comprises a prior authorization module programmed to make available to the prescriber a request for prior authorization of the prescription medication for the patient.

20. The system of claim 19, wherein the prior authorization module is programmed to select a prior authorization request form based at least in part on the medication and a health insurance plan for the patient.
